(19) United States
(12) Patent Application Publication
(10) Pub. No.: US 2006/0026178 A1
(43) Pub. Date: Feb. 2, 2006

(54) Method and apparatus for adapting an email application program user interface to interface with a business management system

(76) Inventors: Werner G. Wolf, Wiesloch (DE); David L. Sacks, Bedford, NH (US)

Correspondence Address: KENYON & KENYON, 1500 K STREET NW, SUITE 700, WASHINGTON, DC, 20005, US

(21) Appl. No.: 10/927,443

(22) Filed: Aug. 27, 2004

Related U.S. Application Data
(60) Provisional application No. 60/588,393, filed on Jul. 16, 2004.
(60) Provisional application No. 60/588,391, filed on Jul. 16, 2004.

(51) Int. Cl. G06F 7/00

(52) U.S. Cl. 707/100

(57) ABSTRACT

Methods and apparatus are provided for using the user interface of an email application program to interface with objects in a business management system. In an embodiment, a request to interface with an object in a business management system is received at a user interface for an email application program, and the received request is sent to the business management system to be processed.

### BACKGROUND

The present invention relates to electronic mail and business management systems.

Electronic mail, or “email,” is the transmission of private messages such as text entered from a keyboard (and/or or an electronic file stored on a disk) over communications networks. Email messages are typically addressed to the private electronic mailbox of an individual recipient or group or recipients. An email system typically stores received messages in the electronic mailbox at least until the recipient fetches the message, at which point the recipient may take one or more actions by entering commands/requests to the email application program's user interface, such as forwarding the message to another email user, replying to the message, deleting the message, saving the message within a folder in the email system, etc. As used herein, an application program's user interface is an interface that handles the input and output of information between the application program and the user of the application program, and may include a display screen as well as instructions that support the input and output of information to the application program. The user interface includes screens that are standard for the application program as well as add-in features, if any, that may be added to the user interface.

Email systems generally comprise a computer system directly or remotely executing a software program that manages email for a user or group of users. An email application program may also perform other tasks, such as managing a calendar, managing an address book, etc. Some examples of email software are Microsoft Outlook®, Lotus Notes®, Eudora, and Yahoo! Mail®. Email systems may use a format to communicate with other email systems, such as the SMPT protocol or some other standard.

As used herein, a business management system (“BMS”) is a customer relationship management (“CRM”) system, a supplier relationship management (“SRM”) system, or an enterprise resource planning (“ERP”) system. A CRM is a system that manages business interactions between an organization and a customer or partner. For example, a CRM system may allow a company to manage sales or service related interactions with its customers. Examples of CRM software are SAP Business One® and Oracle CRM®. An SRM system is a system that enables businesses to manage their relationships with their suppliers and vendors, and an SRM's functionality typically includes interaction management, bid management, etc. In many respects, these interactions are similar to those in a CRM system. Examples of an SRM system are SAP Business One® and Oracle SRM®. An ERP system is a system that allows an enterprise to share customer, product, competitor and market information. Examples of an ERP management system are SAP Business One®, Great Plains™, MAS200™, and Netsuite.

A business management system maintains its information as “objects,” which as used herein are data objects native to the business management system that are associated with one or more actions/functions that may be performed on the object. An example of an object is a transactional object or a business object, such as a customer business object or a quotation business object.

Among other things, the present inventors perceived a need in the art to facilitate interaction with transitional objects in a business management system.

### BRIEF DESCRIPTION OF THE DRAWINGS

FIG. 1 is a simplified block diagram that illustrates a network in which the user interface of an email application program may be used to interface with a business management system according to an embodiment of the present invention.

FIG. 2 is a simplified block diagram that illustrates stored software and records associated with an email application program and business management system according to an embodiment of the present invention.

FIG. 3 is a simplified block diagram that illustrates a listing of quotation objects at the user interface of an email application program according to an embodiment of the present invention.

FIG. 4 is a screen shot of a window for viewing information for a quotation according to an embodiment of the present invention.

FIG. 5 is a screen shot of an example of an email message generated from a full quotation view window according to an embodiment of the present invention.

FIG. 6 is a screen shot of an example of a word processing-format document created for a quotation according to an embodiment of the present invention.

FIG. 7 is a simplified flow chart for a method for using the user interface of an email application program to interface with objects in a business management system according to an embodiment of the present invention.

### DETAILED DESCRIPTION

The present invention provides methods and apparatus for using the user interface of an email application program to interface with objects in a business management system. Such an object may be, for example, a transactional object. In some embodiments, a user of an email application program may be able to fulfill tasks on a separate business management system without leaving the environment of the email application program. Such a user may be able to add or change objects (e.g., business objects) within the business management system from within the user interface of the email application program. In some embodiments, the data may only be stored in the BMS database and retrieved from the BMS database, and there may be no synchronization into data maintained by the email application program. In some embodiments, changes made to an object may be seen immediately in the BMS.

According to some embodiments, the full set of BMS transactions that a sales employee or sales/service representative may need is provided at the user interface of the email application program. As an example, new quotation business objects may be created or existing quotations updated using the same business logic at the BMS. For example, if there are business rules governing valid quotations, those same rules may apply to quotations entered either in the BMS directly or via the application program interface. For example, if quotations may not have a discount greater than 15%, then if a quotation was entered with a discount in excess of 15%, a business rules engine may intercept that quotation and follow a prescribed process (i.e. notify manager, route to manager, reject outright, etc.) In some embodiments, the user is able to get a list of BMS objects (e.g., quotations) at the email application program user interface (“UI”). Such a list may be a snapshot according to specific settings (e.g., the open quotations for that user).

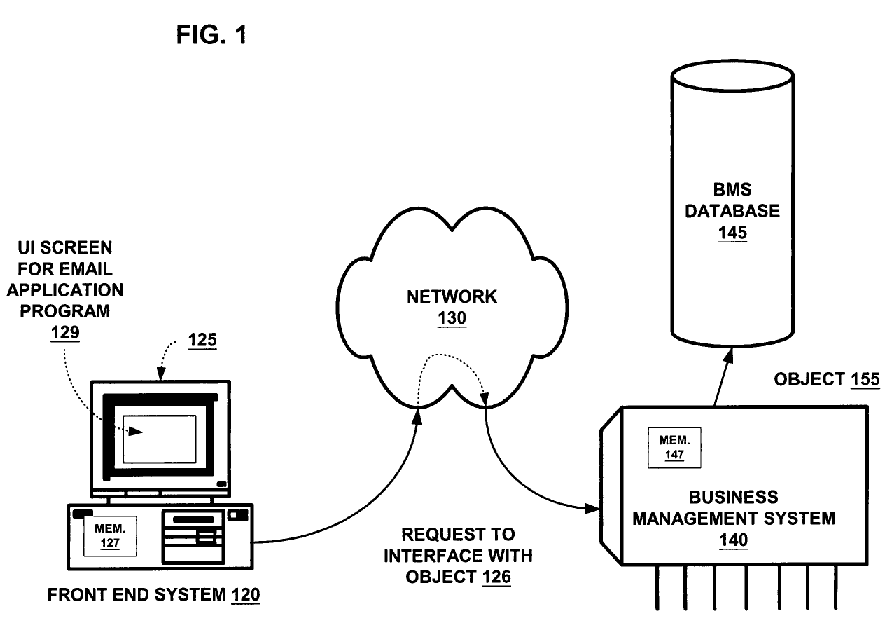

FIG. 1 is a simplified block diagram that illustrates a network in which the user interface of an email application program may be used to interface with a business management system according to some embodiments of the present invention. FIG. 1 shows a front end system 120 and a BMS 140 that are coupled together over a network 130. Network 130 may be any type of network for communicating information, such as a local area network (LAN), wide area network (WAN), the Internet, or an intranet. Front end system 120 may be any type of device for managing email, such as for example a personal computer, a terminal, a personal digital assistant (PDA), etc. Front end system 120 may contain a display 125 to display information and a memory 127 that may store data and software programs. Memory 127 may be, for example, a Random Access Memory (RAM). Memory 127 may be a machine readable medium which stores a computer program (which as is well known comprises a plurality of instructions) that is executable by a computer system, such as front end system 120. A machine readable medium is any medium cable of being read by a machine, such as a floppy disk memory, CD-ROM, etc. In the embodiment shown, front end system 120 is capable of executing application software. Display 125 is shown in FIG. 1 as displaying a user interface screen 129 for an email application program.

BMS 140 may be a terminal server, mainframe computer, or any type of computer system that maintains a business management database. As shown, BMS 140 contains a memory 147 (e.g., a RAM) which may store data and application programs. In addition, BMS 140 is shown coupled to a BMS database 145, which may be any type of computer readable medium, such as one or more hard disk memories, that stores instructions and data for a system that maintains a collection of data to support a decision making process. BMS database 145 may contain a plurality of data objects. BMS 140 may be referred to as a back-end system. Typically, many front-end systems may be coupled to the back-end system through network 130.

As shown in FIG. 1, front end system 120 may receive email messages over network 130 and execute email application software to allow a user to process such messages. This email application program is shown presenting a user interface screen 129 through which as a user may process email, as is well known, and in addition may make requests to interact with an object on BMS 140. Front end system 120 is shown sending to BMS 140 a request to interface with an object 126 in BMS 140, and BMS 140 is shown sending BMS database 145 an object 155 to be stored in BMS database 145.

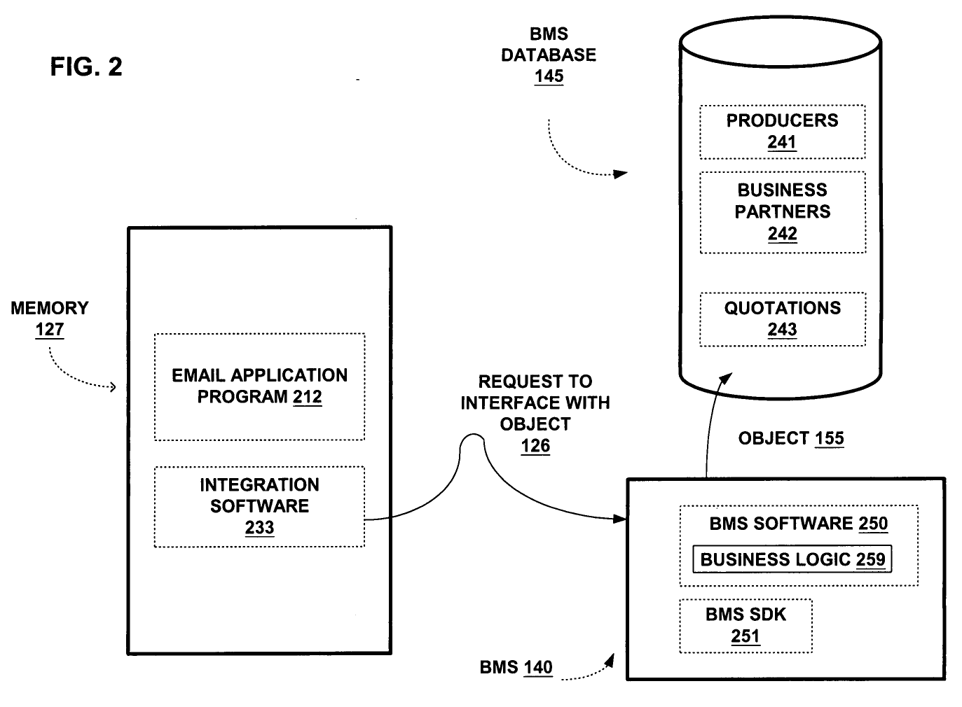

FIG. 2 is a simplified block diagram that illustrates stored software and records associated with an email application program and business management system according to an embodiment of the present invention. In addition to request to interface with object 126, object 155, BMS 140, and BMS database 145 of FIG. 1, FIG. 2 also shows memory 127 of front end system 120 storing email application program 212 and integration software 233. Email application program 212 may be a software program, such as Microsoft Outlook®, that is executed by front end system 120 to manage email for a user of front end system 120. In the embodiment shown, integration software 233 integrates applications at front end system 120 with business management system 140. Integration software 233 may be automatically initiated at the start-up of front end system 120 or of the email application program 212 and may integrate itself into a user interface of front end system 120. Integration software 233 may include instructions or calls to instructions that add-in features to the user interface of the email application program. In some embodiments, integration software 233 is a software add-in to front end system 120 that adapts the user interface of the email application program to enable it to integrate with the BMS and to exchange information electronically.

BMS 140 is shown in FIG. 2 as storing BMS software 250 and BMS software development kit (“SDK”) 251, which may be stored in memory 147. BMS software 250 may be a software program that manages BMS database 145. For example, BMS software 250 may add new records, modify records, or perform other activities on records in BMS database 145. As shown, BMS software 250 may contain business logic 259, which may be instructions to implement the business logic of BMS 140. BMS database 145 is shown including records for a plurality of objects, which include products 241, business partners 242, and quotations 243. As used herein, a “business partner” refers to a customer data object, vendor or lead, and a “quotation” refers to a price quotation data object that was provided either orally, electronically or in writing to a customer or potential customer.

For example, business partners 242 may include records that have data for a business partner of a user of BMS 140 (e.g., a supplier), products 241 may include records that have data for a product of a user of BMS 140, and quotations 243 may include records that have data for a price quotation that was previously given to a customer. Of course, BMS database 145 may also store records for objects different than and in addition to those shown, such as for example orders, invoices, service calls, sales opportunities, bank details, etc.

FIG. 2 shows request to interface with object 126 being sent from integration software 233 of front end system 120 to BMS 140. Request to interface with object 126 may be generated, for example, if a user who is executing email application program 212 on front end system 120 inputs a request to front end system 120 that a BMS object, such as a quotation, be created. In some embodiments, integration software 233 contains functionality to cause the reading, writing, modification or creation of data objects in BMS 140. In response to request to interface with object 126, BMS 140 may send data for new object 155 to be stored in BMS database 145, for example as a new quotation record in quotations 243.

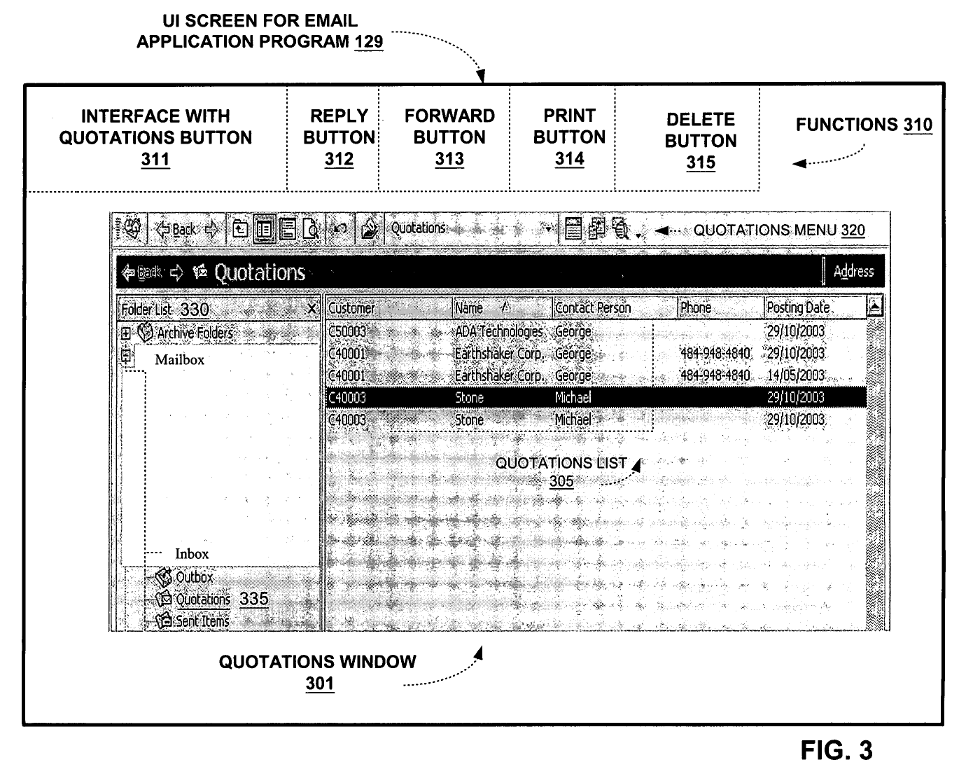

FIG. 3 is a simplified block diagram that illustrates a listing of quotation objects at the user interface of an email application program according to an embodiment of the present invention. FIG. 3 shows user interface screen 129 for an email application executing on front end system 120. User interface screen 129 is displaying a quotations window 301 that includes a quotations list 305, with each quotation listed being a data object stored in BMS system 140. User interface screen 129 is also shown as displaying an plurality of functions 310 that may be performed by a user of the email application program. These include a sample of email functions that may be performed, such as reply button 312, which may allow a user to reply to an email message; forward button 313, which may allow a user to forward an email message to another email user; print button 314, which may allow the user to print an email message; and delete button 315, which may allow the user to delete an email message. At another time, and as is well known, the user interface shown in user interface screen 129 may display an email message, which may include an email header as well as text, and may be used to perform operations on the email message such as those discussed above.

One of the functions 310 shown in the embodiment of FIG. 3 is a button to interface with quotations 311. In this embodiment, a user of front end system 120 who is executing email application program 212 may select button 311 in order to interface with a quotation object on BMS 140, which may cause the display of quotation window 301 and its quotations list 305, which may contain all the quotations for a user of BMS 140 (who may also be the user of front end system 120). In this example, quotations list 305 lists five different quotations and, for each, contains a customer number, name of the company receiving the quotation, contact person and phone number (if available) at the company receiving the quotation, and date that the quotation object was posted to BMS 140. Each of the listed quotations may be stored as separate records in BMS database 145 (e.g., as part of the quotations 243).

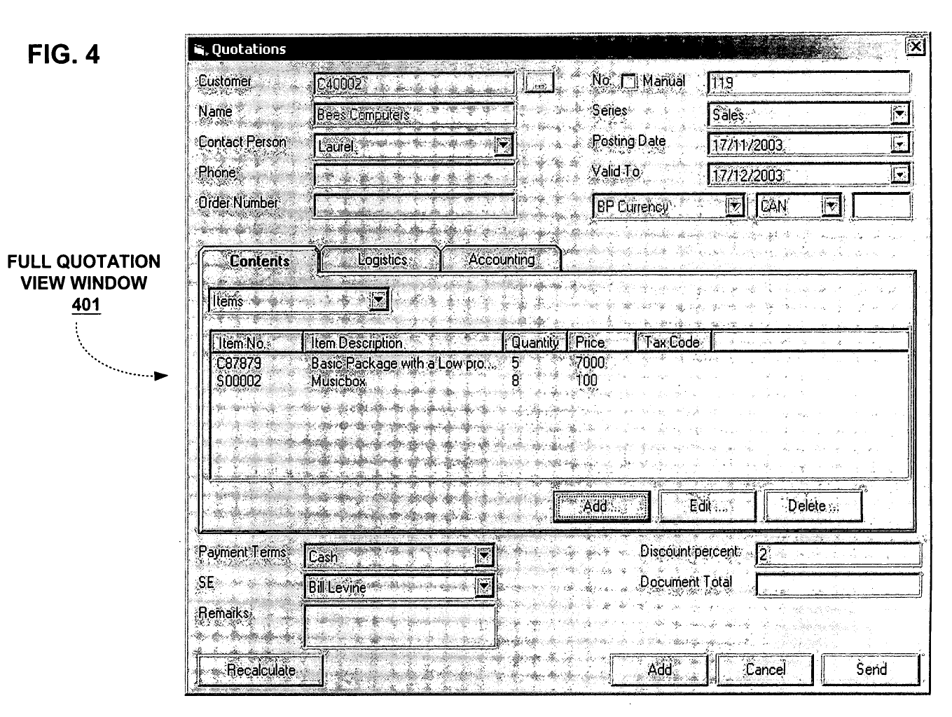

In addition to the quotations list, quotations window 301 in this example also contains a quotations menu 320 and a folder list 330. By selecting icons on quotations menu 320, a user may be able to interface with quotations, such as printing a quotation or selecting a full view of the quotation. According to some embodiments of the present invention, a user may select a window that contains a full view of the information for a quotation. A screen shot with an example of such a full quotation view window, according to an embodiment of the present invention, is shown in FIG. 4, which is described in more detail below. For example, a user may double-click on one of the quotations in quotations list 305, or select a button on quotations menu 320, to see a full view of that quotation.

In some embodiments, a user may filter the quotations shown on quotations list 305, for example by using a button on quotations menu 320. For example, a user may choose to show only his/her quotations or quotations for all users. In addition, a user may choose to show only closed quotations, only open quotations, or any quotation regardless of whether open or closed. As another example, a user may also choose to show only quotations within a range of dates.

By selecting one of the folders listed on the folders list 330 of FIG. 3, the user may be able to select an email folder or, in this embodiment, may also be able to select the quotations window 301 (by selecting the quotations 335 icon). In some embodiments, the quotations icon 335 may be selected from any view in the user interface of the email application program, and in some embodiments this may be the only way to select the quotations window 301.

In some embodiments, the user may select buttons to select a list of other types of objects to interface with, such as orders, products, invoices, service calls, sales opportunities, bank details, etc. In some embodiments, the user interface shown may contain a button that causes a display of a menu of types of objects to be shown.

Other than quotations window 301, the user interface shown in user interface screen 129 may be a typical user interface for an email application program. In this embodiment, the quotations objects that are listed in quotations window 301, and which a user may interface with at the user interface of the email application program, are all maintained at the BMS 140, and none of this data is stored (except transitorily) at front end system 120. In some embodiments, BMS 140 contains all of the business logic to interface with these objects, and front end system 120 does not contain any business logic.

FIG. 4 shows full quotation view window 401 that allows a user to interact with the quotation object that is shown. In this embodiment, full quotation view window 401 includes the customer number, name of the company receiving the quotation, contact person and phone number at the company receiving the quotation, and date that the quotation object was posted, as discussed above with regard to quotations list 305. In addition, full quotation view window 401 may include a date until which the quotation is valid, the payment terms, and discount information, as well as a contents tab, logistics tab and accounting tab. The contents tab may allow the user to add, edit, delete, or view information about the items that are the subject of the quotation. The shipping tab may allow the user to add, edit, delete, or view shipping and billing related information about the quotation, and the accounting tab may allow the user to add, edit, delete, or view accounting related information about the quotation. Of course, in some other embodiments different information or functionality may be presented.

In some embodiments, any information that is entered into full quotation view window 401 may be stored as part of an object at BMS 140, for example after the user presses an add button. In some other embodiments, the user may cause the BMS 140 to calculate information relating to the quotation, for example by pressing the recalculate button. In some embodiments, any business logic for performing actions on the quotations object is located at the BMS, not at the front end system.

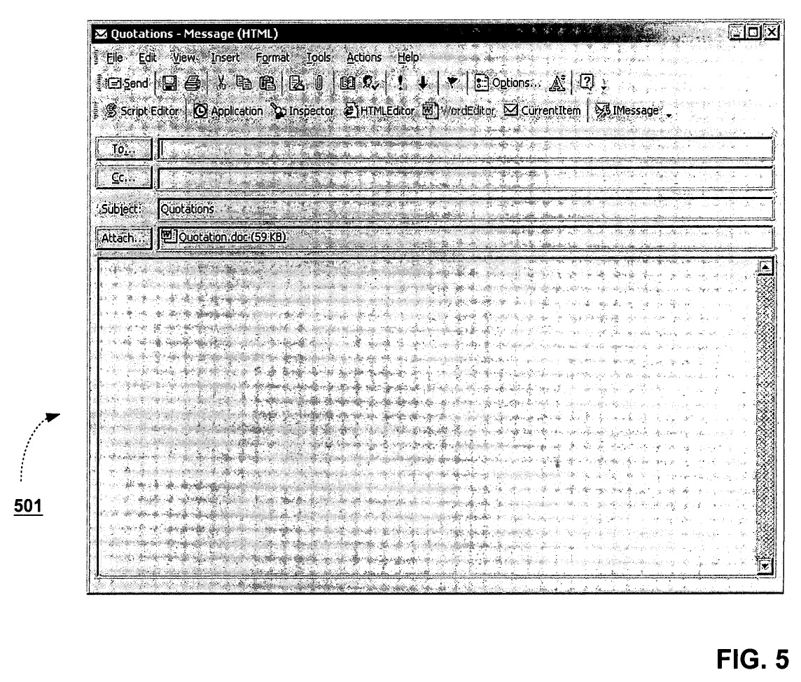

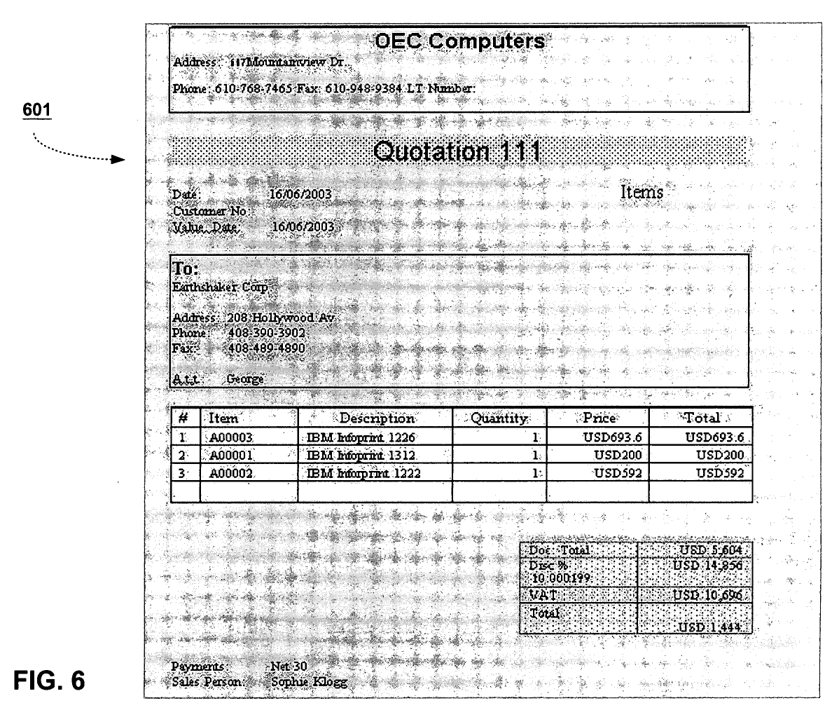

In some embodiments, from the full quotation view window 401 a user may cause a document to be created (e.g., by pressing a send button) for the quotation in a standard word processing format and an email to be generated to a person who is to receive that quotation. According to some embodiments of the present invention, a screen shot with an example of such an email that was automatically generated from the full quotation view window 401 is shown in FIG. 5, and an example of a word processing-format document created for that quotation and attached to the email is shown in FIG. 6. FIG. 5 contains an email message 501 that was created from full quotation view window 401 and that may be emailed to a recipient. FIG. 6 shows the contents of a quotation document 601 that is an attachment to email message 501.

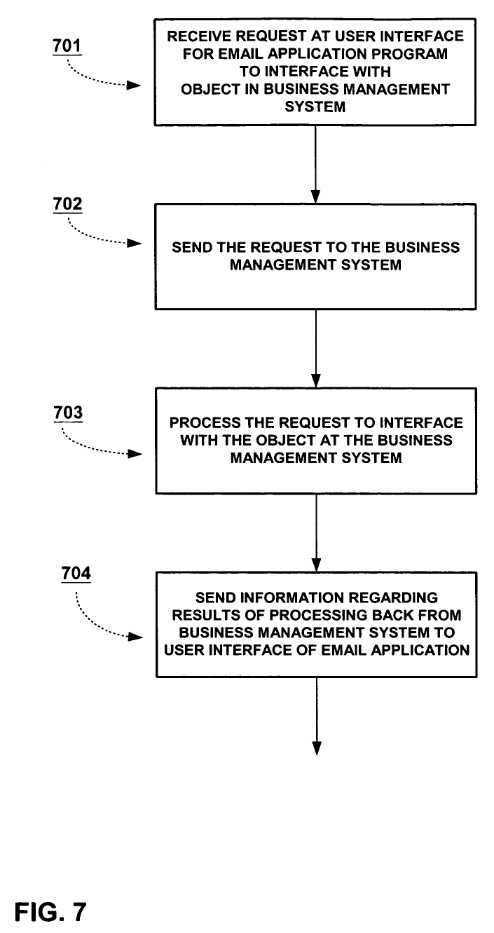

FIG. 7 is a simplified flow chart for a method for using the user interface of an email application program to interface with objects in a business management system according to an embodiment of the present invention. This method may involve a first computer system displaying a user interface for an email application program, such as the user interface screen 129, and a second computer system that maintains a business management system, such as BMS 140. A request to interface with an object in the business management system may be received at the user interface for an email application program executing on a first computer (701). The request may be sent from the first computer system to the business management system at a second computer system to be processed (702). The request may be processed and sent from the first computer system to the second computer system by an add-in software module at the first computer system. The object may be, for example, a quotation object. In some embodiments, the request may be a request to add a new object to a database at the business management system, to modify an object in a database at the business management system, or to send information relating to the object from the second computer system to the first computer system to be displayed by the user interface for the email application program. The request may be processed at the business management system (703), which may involve invoking business logic at the business management system and may cause an object to be created or modified. Information regarding the results of the processing may be sent back from the business management system to the first computer (704).

In some embodiments, the first computer system includes a machine readable medium having embodied thereon instructions to be executed to adapt the user interface of an email application program to receive a request to interface with an object in the business management system, for example by using quotations button 311, quotations window 301, and associated functionality. Such a machine readable medium at the first computer may also have embodied thereon instructions to forward the request to a second computer system that maintains a business management system. The business management system may comprise a computer that stores instructions to interface with an object. In some embodiments, stored instructions adapt a user interface of an email application program to receive a request to interface with an object in the business management system and forward the received request to the business management system. The instructions to adapt the user interface of the email application program may comprise an add-in software module.

The above is a detailed discussion of certain embodiments. It may be understood that the examples discussed are for illustration purposes only and are not intended to limit the configuration to that shown. For example, a user may interface with any object at the business management system, in addition to quotations as shown above. Similarly, buttons or other mechanisms may be used instead of menus to provide access to functions. As another example, the order of the steps performed may be varied as appropriate. It is of course intended that the scope of the claims may cover other embodiments than those described above and their equivalents.

What is claimed is:

1. A method comprising:
receiving at a user interface for an email application program a request to interface with an object in a business management system; and
sending the received request to the business management system to be processed.

2. The method of claim 1, wherein the object is one of a quotation, sales order, service call, sales opportunity, sales forecasts, contracts, delivery notes, returns, invoices, credit notes, purchase order, prices.

3. The method of claim 2, wherein the request comprises a request to modify or delete an object of in a database at the business management system.

4. The method of claim 1, wherein the request comprises a request to add a new object to a database at the business management system.

5. The method of claim 1, wherein the email application program is executing on a first computer system, and wherein the business management system comprises a second computer system.

6. The method of claim 5, wherein the request comprises a request to send information relating to the object from the second computer system to the first computer system to be displayed by the user interface for the email application program.

7. The method of claim 5, wherein sending the received request causes the invocation of business logic at the second computer system, and wherein the first computer system does not have any business logic.

8. The method of claim 5, wherein the request is sent from the first computer system to the second computer system by an add-in software module at the first computer system.

9. A machine readable medium having embodied thereon instructions executable by a computer system to perform a method comprising:
receiving at a user interface for an email application program a request to interface with an object in an business management system; and
sending the received request to the business management system to be processed.

10. The machine readable medium of claim 9, wherein the object is one of a quotation, order, service call, sales opportunity, sales forecasts, contracts, delivery notes, returns, invoices, credit notes, purchase order, prices.

11. The machine readable medium of claim 10, wherein the request comprises a request to modify or delete an object in a database at the business management system.

12. The machine readable medium of claim 9, wherein the request comprises a request to add a new object to a database at the business management system.

13. The machine readable medium of claim 9, wherein the email application program is executing on a first computer system, and wherein the business management system comprises a second computer system.

14. The machine readable medium of claim 13, wherein the request requires sending of information relating to the object from the second computer system to the first computer system to be displayed by the user interface for the email application program.

15. The machine readable medium of claim 13, wherein sending the received request causes the invocation of business logic at the second computer system, and wherein the first computer system does not have any business logic.

16. The machine readable medium of claim 13, wherein the request is sent from the first computer system to the second computer system by an add-in software module at the first computer system.

17. A machine readable medium having embodied thereon instructions to be executed by a computer, the instructions comprising instructions to:
adapt the user interface of an email application program on a first computer to receive a request to interface with an object in an business management system; and
forward the request to interface with an object received at said user interface to a second computer system that maintains a business management system.

18. The machine readable medium of claim 17, wherein the object is one of a quotation, order, service call, sales opportunity, sales forecasts, contracts, delivery notes, returns, invoices, credit notes, purchase order, prices.

19. The machine readable medium of claim 18, wherein the request comprises a request to modify or delete an object in a database at the business management system.

20. The machine readable medium of claim 17, wherein the request comprises a request to add a new object to the business management system.

21. The machine readable medium of claim 17, wherein the request requires sending information relating to the object from the second computer system to the first computer system to be displayed by the user interface for the email application program.

22. The machine readable medium of claim 17, wherein sending the received request causes the invocation of business logic at the second computer system, and wherein the first computer system does not have any business logic.

23. The machine readable medium of claim 17, wherein the request is sent from the first computer system to the second computer system by an add-in software module at the first computer system.

24. A system comprising:
a business management system comprising a first computer that stores instructions to interface with an object; and
a second computer that stores instructions to adapt a user interface of an email application program to receive a request to interface with an object in said business management system and forward the received request to the first computer.

25. The system of claim 24, wherein said instructions to interface with an object comprises business logic instructions.

26. The system of claim 25, wherein the second computer does not store any business logic instructions.

27. The system of claim 24, wherein the first computer stores instructions to receive a request from the second computer to interface with an object.

28. The system of claim 24, wherein the object is one of a quotation, order, service call or sales opportunity.

29. The system of claim 24, wherein the request comprises a request to add a new object to a database at the business management system.

30. The system of claim 24, wherein the request comprises a request to modify an object in a database at the business management system.

31. The system of claim 24, wherein the request requires sending information relating to the object from the first computer to the second computer to be displayed by the user interface for the email application program.

32. The system of claim 24, wherein said instructions stored on the second computer to adapt the user interface of the email application program comprise an add-in software module at the second computer.
